(19) United States
(12) Patent Application Publication
(10) Pub. No.: US 2004/0095375 A1
(43) Pub. Date: May 20, 2004

(54) Method of and apparatus for interactive specification of manufactured products customized with digital media

(76) Inventors: Christopher Paul Burmester, Oakland, CA (US); Corinne Wayshak, Los Altos, CA (US); Goffrey Scott Mitchell, Los Gatos, CA (US); Ruth Michelle Lassman, Mountain View, CA (US)

Correspondence Address: HAVERSTOCK & OWENS LLP, 162 NORTH WOLFE ROAD, SUNNYVALE, CA, 94086, US

(21) Appl. No.: 10/436,930

(22) Filed: May 12, 2003

Related U.S. Application Data
(60) Provisional application No. 60/379,962, filed on May 10, 2002.

(51) Int. Cl. G09G 5/00

(52) U.S. Cl. 345/716

(57) ABSTRACT

The present invention is specifically related to the application of photographic imagery onto pieces of confetti and more generally to a technology and process which affords the creation of customized products using digital media and the interactive creation of manufacturing specifications. The invention presents a method for mediating a non-interactive process for the transfer of queued customizing content and specifications to the remote manufacturing server concurrent with the interactive selection of content and derivation of manufacturing specifications. The method of mediation maximizes bandwidth utilization while minimizing interactive transfer latencies. The invention also teaches methods by which the full range of image manipulation processes required to specify and preview the product are accomplished via client side routines and locally stored source material such that remote server intervention and network latencies need not be incurred to facilitate the user specification of the product.

### RELATED APPLICATIONS

This application claims priority under 35 U.S.C. § 119(e) of the co-pending U.S. provisional application Serial No. 60/379,962 filed on May 10, 2002 and entitled “PROCESS AND TECHNOLOGY FOR CREATING PERSONALIZED PRODUCTS WITH PHOTOGRAPHIC IMAGERY.” The provisional application Serial No. 60/379,962 filed on May 10, 2002 and entitled “PROCESS AND TECHNOLOGY FOR CREATING PERSONALIZED PRODUCTS WITH PHOTOGRAPHIC IMAGERY” is also hereby incorporated by reference.

### FIELD OF THE INVENTION

The present invention relates to the field of interactive customized design and manufacturing utilizing electronic based media, and more particularly relates to the mass production of confetti customized with photographic imagery on the surface of the confetti. The invention also relates to the creation and production of confetti customized with photographic imagery.

### BACKGROUND OF THE INVENTION

Confetti is widely used in celebrations as a decoration and ornament. It is generally mass produced and is found in a variety of shapes and colors and aerodynamic properties. (See U.S. Pat. Nos. D385,824; D395,617, D397,640; D408,615; D403,986; D410,594; D410,410; D428,582; D65410; 6,027,773; 5,797,304; 5,643,042; 5,507,680.)

While these inventions may provide basic themes, bells for a wedding shower as an instance, there is nothing in the field of confetti that provides a more personalized or customized product for a celebratory gesture.

As well, while the above-referenced patents teach confetti having particular shapes, none of the above-referenced patents teaches the concept of having photographic imagery on the pieces of confetti.

Additionally, none of the above-referenced patents teaches the processes by which copyright holders of personalized content may interact with a technology and service to enable the creation of personalized products including, but not limited to, confetti with photographic imagery on its surface.

Many services offer manufactured products that may be customized with one or more digital media content files. One such class of content is photographic images. A client wishing to customize a product with multiple personal images is currently required to select and transmit multiple files to the manufacturing services along with specifications as to how the transmitted content was to be used to customize the product. Services that allow users to customize products with personal content typically ask the client to transmit any content to the remote service in advance of allowing the client to customize and order a product. As these content files are typically very large and the transfer rate of communications conduits is relatively small, the transfer times are great leading to sizable delays in service.

The time a user has to wait while content is transferred between a client and a server is directly related to the user's experience and feeling about using a service. Generally, the user's experience and feeling about using a service is directly related to if and how often the user will return to a service. If a user has to wait for long periods of time while the content is transferred, the user is not likely to have as good an experience and feeling about the service. On the other hand, if the user can perform other tasks or better utilize the time while the content is transferred between the client and the service, the user is more likely to have an enjoyable experience and utilize the service again.

Additionally, clients of such services must provide detailed and non-intuitive textual descriptions of how a product offering should be customized with selected content files.

### SUMMARY OF THE INVENTION

In the present invention, a technology and process is created which affords the creation of customized products using digital media.

In one aspect of the present invention, a client accesses the technology service by means of a data communications conduit. The invention in this form furnishes an interactive service by which the user may select digital content media, interactively specify how a product should be customized with the selected content, and obtain a preview of the desired end-product customized in the manner specified. Concurrent with this interactive service, the selected digital media content and the customization specifications derived by the interaction with the service is transmitted to the service provider over the same data communications conduit via a non-interactive process. This non-interactive process manages the transmission of the digital content and specifications to the remote service in a manner that can be either concurrent or alternating or both, but gives priority to client interactions with the remote service via the shared communications conduit. The digital content media used to customize the product is preferably digital photograph, video, textual, audio content or files. The content media is stored locally or at a remote location which is identified by an address or Uniform Resource Identifier. The specifications are instructions to the service on how the client wishes the product to be customized with the selected content, as derived via their interaction with the service to obtain the desired preview, and can include digital data in any form. Within the preferred embodiment, the specifications include textual and numerical data specifying, for example, color choices, digital photo scaling and rotation, and positioning coordinates.

In the preferred embodiment of the present invention, a client accesses a service via a data communications network, such as the Internet, to specify the manufacture of confetti customized with imagery on its surface. The service furnishes an interactive process by which the client selects one or more digital images, interacts with each image to specify the portion, size, scaling, and shape to be placed on the confetti product, and shapes, colors, patterns and textual information to be placed on the confetti product. At any step in the interactive process, the client can obtain a preview of the confetti product based on the specifications provided to that point. Concurrent with the interactive specification process, any digital images selected and specifications created are transmitted to the remote service, if necessary, when the data communications network is not busy or impacted with the communications of interactive requests between the client and the remote service.

An instance of the invention in this form is the technology provided in the form of an interactive web site housed on one or more network computer servers which the customer can access at will as a service to create and order customized products, in particular, confetti with photographic imagery on its surface from the customer's personal digital photographic media.

In another aspect of the present invention, an end user interacts with the technology and process provided in the form of a locally stored or “desktop computer-based” software service. The invention in this form provides an interactive service by which the user can work locally on a personal digital computer or device or public kiosk or device to create a personalized product whose specifications and selected personal content is sent to a remote fulfillment service concurrently with the interactive session via a non-interactive process which is managed so as to not impact the interactive session. As one instance of the invention in this form, customers work with software installed on their personal computer and interact with a service accessible via a data communications network, such as the Internet.

In all aspects, the invention includes the processes and enabling technologies that allow the selection and conveyance of the personal digital media to the product manufacturer, the specification of the customized nature of the product, and the means by which these customized specifications are used to create specific personalized orders of the product. An instance of this invention process and technology is reduced to practice for the creation of confetti with personalized photographic imagery on its surface together with customizing elements of the product. For this product, the technology of conveyance uses dynamic HTML, Common Gateway Interface (CGI), C and C++ programming languages, and JavaScript technologies in a novel manner to allow customers to assemble a list of photographic digital images from which they intend to create a customized confetti product. The technology allows the customer to immediately start the creation of the personalized product while the list or queue of selected images and derived manufacturing specifications are conveyed to the manufacturing site in a separate and concurrent process. For this product, the technology of specifying the customized nature of the product includes selecting specific images, selecting customer accent confetti color themes and form factors (including but not limited to size and shape), specifying, positioning, and formatting a personalized text message or messages, and scaling, panning, rotating, applying graphic filters and processing methods, and cropping the image to specify the content to appear on the surface of the confetti. For the non-interactive processes mediating the conveyance of manufacturing specifications derived from the interactive process and the selected customizing digital media content, the mediation includes the verification of receipt of conveyed content at the remote service location, the suspension and resumption of transmission to avoid impact on the interactive session utilizing the shared transmission conduit, the automatic retransmission of failed transmissions, and confirmation of the completion of transmission of all specifications and content required to create the specified product.

The subject invention will be more readily understood upon consideration of the following detailed descriptions and accompanying drawings.

### BRIEF DESCRIPTION OF THE DRAWINGS

FIG. 1 illustrates a system of the present invention for customizing products for manufacture with selected digital media content that affords the non-interactive transfer of content and specifications concurrent with the interactive customizing of the product.

FIG. 2 illustrates a block diagram of the hardware for customizing products for manufacture with selected digital media content of the preferred embodiment of the present invention.

FIG. 3 illustrates the preferred embodiment of the interactive process 410 flow and non-interactive process 420 flow of FIG. 1 for customizing confetti for manufacture with selected digital photography that affords the non-interactive transfer of selected content and specifications concurrent with the interactive customizing of the confetti.

FIG. 4 illustrates the preferred embodiment of the conduit manager 430 flow of FIG. 1 for customizing confetti for manufacture with selected digital photography that affords the non-interactive transfer of selected content and specifications concurrent with the interactive customizing of the confetti.

### DETAILED DESCRIPTION OF THE PREFERRED EMBODIMENT

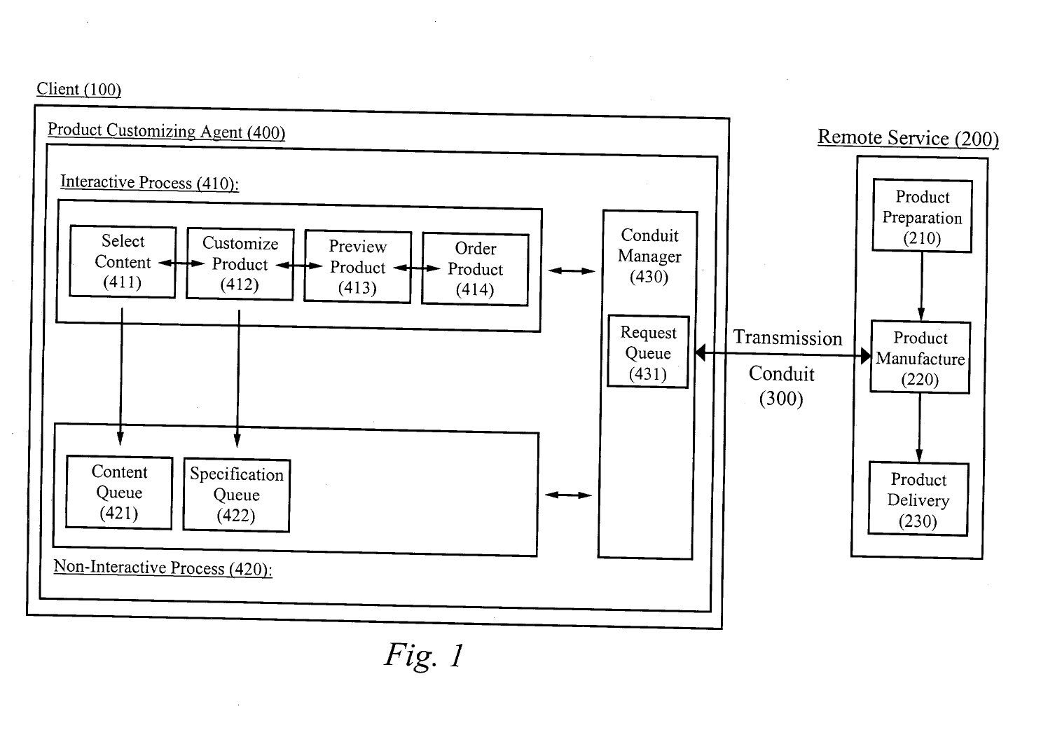

In a first aspect of the invention, a client is enabled to interact with a remote service to interactively customize a manufactured product with digital media content. FIG. 1 illustrates this aspect of the invention. FIG. 1 shows a client 100 communicating with a remote service 200 via a transmission conduit 300 to receive and store locally a product customizing agent 400. The agent 400 can be sent in whole or in parts. As shown in FIG. 1, the agent 400 enables the client 100 by means of an interactive process 410 to select digital media content 411, customize the manufacture of the product 412, preview the customized product 413, and order the product 414. As used herein, digital media content is preferably any content of digital format including photographic imagery, video, audio, and textual content or files. The agent 400 depicted in FIG. 1 responds to interactive customization activity by storing selected content references in a content queue 421 and derived manufacturing specifications in a specification queue 422 via a non-interactive process 420. Both the interactive process 410 and the non-interactive process 420 of FIG. 1 communicate with the remote service 200 through a shared communications conduit 300 whose access is mediated by a conduit manager 430. The conduit manager 430 prioritizes requests for access to the shared transmission conduit 300 such that the processes 411-414 associated with the interactive customization of the product are not interrupted or impeded by the non-interactive processes associated with the transfer of data in the content queue 421 and the specification queue 422. Requests for access to the conduit manager 430 are accepted until the interactive process 410 order product process 414 is completed. Once the order product 414 process is completed, the interactive process 410 ends and the agent 400 continues operation until all requests queued in the conduit manager 430 have been completed.

The conduit manager 430 controls all access to the communications conduit 300 by acting as a proxy for all interactions with the remote service 200. Requests for interactions with the remote service 200 are sent by the interactive process 410 and the non-interactive process 420 to the conduit manager 430 where they are stored in a request queue 431. The conduit manager 430 then prioritizes the requests for access to the remote service 200 via the communications conduit 300 in the request queue 431 in any appropriate manner. In one aspect, the conduit manager 430 gives the interactive process 410 requests highest priority. In this case, any interactive process 410 request interrupts any active non-interactive 420 request currently accessing the communications conduit 300, thereby gaining immediate access. The interrupted non-interactive 420 request is placed into the request queue 431 for future access to the communications conduit 300. Once all interactive process 410 requests in the request queue 431 have been completed, then the non-interactive process 420 requests in the request queue are allowed access to the communications conduit 300. In this aspect, the non-interactive process 420 requests gain access to the remote service 200 for the purposes of transmitting selected digital media content and customizing manufacturing specifications derived from the interactive process 420 without any degradation of the transmission of interactive process 410 requests to the remote service 200.

The conduit manager 430 receives all responses from the remote service 200 and dispatches these responses to the interactive process 410 and the non-interactive process 420 as appropriate. If a response from the remote service 200 indicates a transmission failure, then the originating request is automatically re-queued for access to the remote service 200. If the response from the remote service 200 indicates that the transmission was in error, then this error is communicated to the originating process where it is handled appropriately. If a response from the remote service 200 indicates that data associated with the non-interactive process 420 must change or is unacceptable, then this data is removed from the content queue and the interactive process 410 is interrupted appropriately to alert the client 100 to appropriate remedial action.

The interactive processes 411-413 can be entirely asynchronous and changeable up to the point with the product order 414 is completed. Any change in the interactive processes 411-413 alters data queued for transfer via the non-interactive process 420 in the content queue 421 and/or the specification queue 422. If such change of data affects data which has not yet been transmitted to the remote service 200, then that data is overwritten in the queues 421-422. If such change of data affects data which has already been transmitted to the remote service 200, then that data is queued for retransmission via the conduit manager 430.

The action of the client 100 via the interactive process 410 automatically creates detailed manufacturing specifications by the action of creating a visual preview 413 of the desired product. The customize product process 412 allows the selected digital content to be manipulated in a fashion allowable by the remote service 200 for the customization of the product. Through the customize product process 412, the selected digital content is redisplayed so as to accurately represent the final product customized with the selected digital content. This representation of the final product is translated into detailed manufacturing specifications by the product customizing agent 400 and queued by the non-interactive process 420 in the specification queue 422. Thus the present invention affords the client to accomplish complicated product specifications by the action of creating an accurate preview of the desired product customized with selected digital media.

The selected digital media can be initially stored locally or remotely with respect to the client 100. In one aspect, the selected digital media is stored locally. In this aspect, the customize product process 412 is immediately available to the client 100 without the need for further communication with the remote service 200. In another aspect, the selected digital media is stored remotely with respect to client 100. In this aspect, the customize product process 412 is available once a communication has been performed with the remote service 100. In a final aspect, the selected digital media is stored in part locally and stored in part remotely with respect to the client. In this aspect, the customize product process 412 is immediately available in part with respect to selected digital media stored locally without communications with the remote service 200 and in all aspects once communications with the remote service 200 have been completed for the purpose of receiving remotely stored content.

Upon product order placement 414, the interactive process 410 of the product customizing agent terminates. Once the subsequent transmission of all conduit manager 430 requests stored in the request queue 431 has completed, the non-interactive process 420 terminates thereby terminating the entire product customizing agent 400 process transferring control via the transmission conduit 300 to the remote service 200. The remote service 200 then uses the received digital media content and derived specifications received by the product customizing agent 400 to complete product preparation 210, manufacture product 220, and deliver product 230.

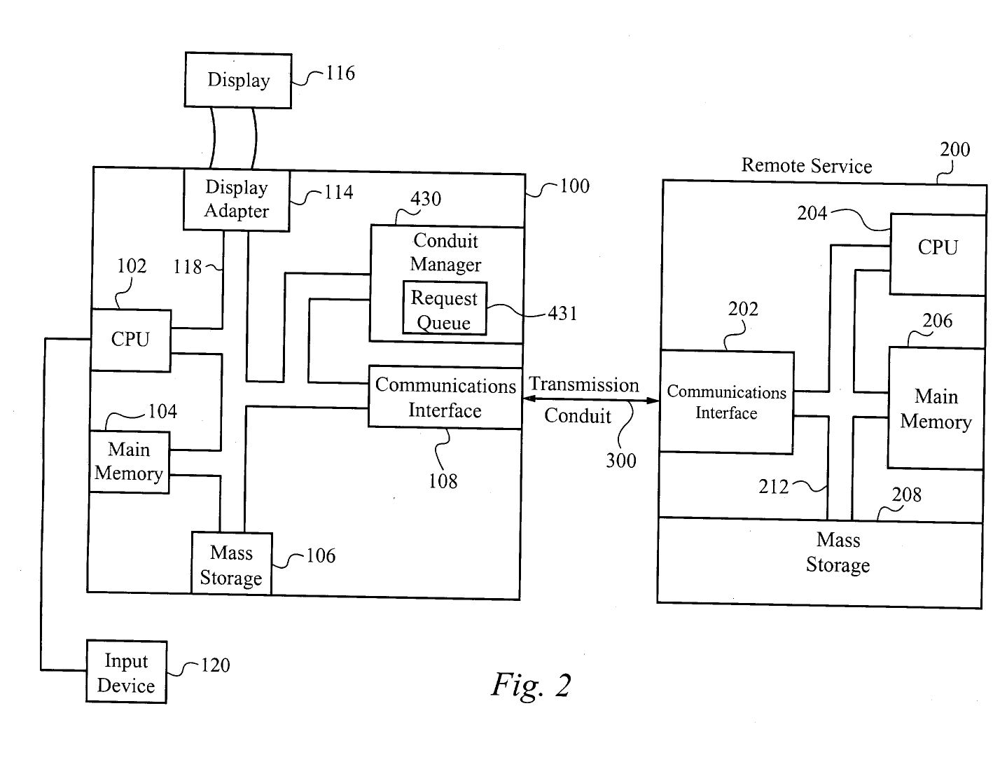

A block diagram of an exemplary network of devices including the client 100 and the remote service 200 is illustrated in FIG. 2. The client 100 is coupled to the remote service 200 by the transmission conduit 300 to allow communications between the client 100 and the remote service 200. The transmission conduit 300 can be any appropriate connection which connects the client 100 to the remote service 200, including a wired connection such as through the public switched telephone network, cable or other appropriate wired or wireless connection, including a satellite link.

The remote service 200 includes a communications interface 202 coupled to the transmission conduit 300. The remote service 200 also includes a central processing unit (CPU) 204, a main memory 206 and a mass storage device 208, all coupled to each other and to the communications interface 202 by a conventional bidirectional system bus 212. The mass storage device 208 may include both fixed and removable media using any one or more of magnetic, optical or magneto-optical storage technology or any other available mass storage technology. The system bus 212 contains an address bus for addressing any portion of the memory 206 and 208. The system bus 212 also includes a data bus for transferring data between and among the CPU 204, the main memory 206, the mass storage device 208 and the communications interface 202.

While the remote service 200 can be accessed from any appropriately configured computer system or access device, an exemplary client device 100 for accessing the remote service 200 is illustrated in FIG. 2. The client device 100 includes a communications interface 108 coupled to the transmission conduit 300. The client device 100 also includes a CPU 102, a main memory 104, a display adapter 114, a mass storage device 106 and a conduit manager 430, all coupled to each other and to the communications interface 108 by a conventional system bus 118. The conduit manager 430 includes the request queue 431, as described herein. The mass storage device 106 may include both fixed and removable media using any one or more of magnetic, optical or magneto-optical storage technology or any other available mass storage technology. The system bus 118 contains an address bus for addressing any portion of the memory 104 and 106. The system bus 118 also includes a data bus for transferring data between and among the CPU 102, the main memory 104, the display adapter 114, the mass storage device 106, the communications interface 108 and the conduit manager 430.

The client device 100 is also coupled to a number of peripheral input and output devices including the input device 120 and the associated display 116. The input device 120 may be any appropriate input device including keyboard, mouse, touch screen or stylus.

The display adapter 114 interfaces between the components within the client device 100 and the display 116. The display adapter 114 converts data received from the components within the client device 100 into signals which are used by the display 116 to generate images for display and provide the customization interface and preview to a user, as described herein.

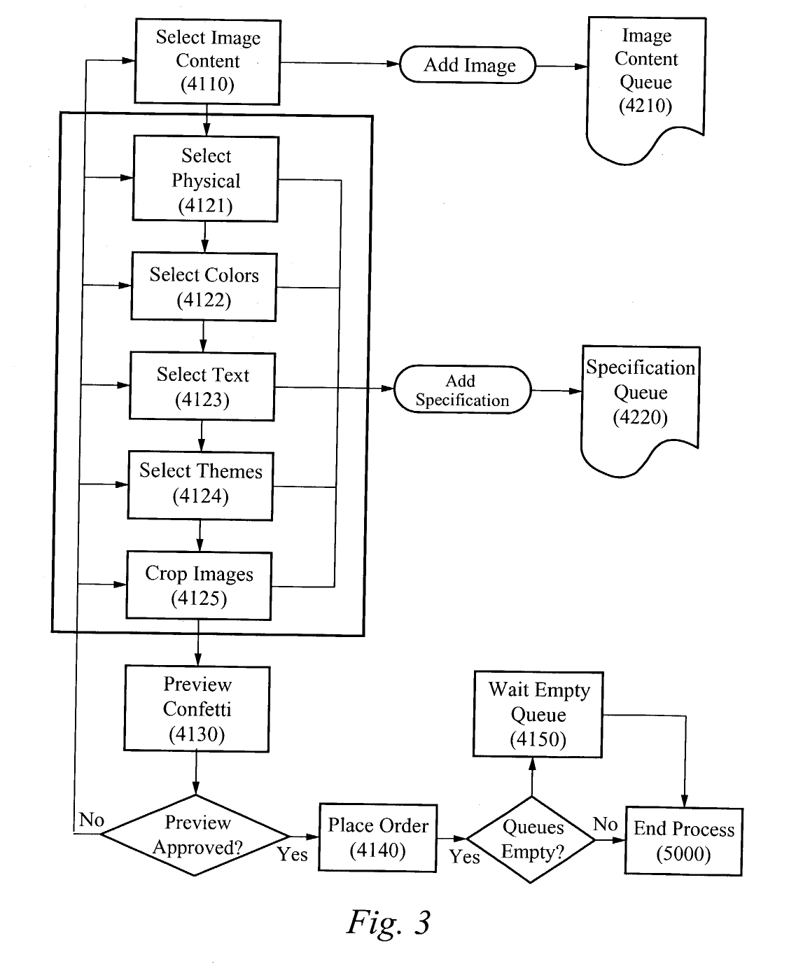

In the preferred embodiment of the present invention, the invention affords the interactive specification of confetti customized with digital photographic imagery. A flowchart of the interactive process 410 and the non-interactive process 420 of the preferred embodiment for customizing confetti for manufacture with selected digital photography that affords the non-interactive transfer of selected content and specifications concurrent with the interactive customizing of the confetti is illustrated in FIG. 3. The invention in this embodiment includes the interactive processes 410 (FIG. 1) that allow the client to receive and interact with an agent to select image content 4110, select manufacturing specifications 4121-4125 for this content, preview the confetti 4130 as specified and customized with digital imagery, and place an manufacturing order for the confetti 4140 as specified, as illustrated in FIGS. 1 and 3. The invention in this embodiment further has non-interactive processes 420 that allow the client to queue selected image content 4210 and manufacturing specifications 4220 for transfer to the remote service 200. As illustrated in the general case in FIG. 1, a client 100 communicates with a remote service 200 by means of a communications conduit 300 to receive a product customizing agent 400. FIG. 3 illustrates the interactive and non-interactive processes illustrated in FIG. 1 further specified in this embodiment of the invention for the specification of confetti customized with imagery.

As illustrated in FIG. 3, the confetti customizing agent enables the client 100 (FIG. 1) to select digital imagery content or files 4110 which are queued for transfer to the remote service 200 in the image content queue 4210. Selected photographic content is identified via an address or Uniform Resource Identifier (URI). In particular, the invention allows the client to select content identified by a URI that identifies content residing locally on the client hardware device or computer supporting the received customizing agent 400. Specifically, the image content resides in files existing on the client hardware or at any other location accessible by an addressable data communications network. In the instance of local content files, this invention allows the client to immediately manipulate digital image content without first incurring any network or transfer latency required to move selected content from a local device where it originally resides to a remote device where the manufacturing operation will occur by accessing the specified image content locally. The invention incorporates technologies that enable the concurrent and simultaneous transfer of selected content to the remote manufacturing device while the client continues interaction with the invention.

The invention incorporates the use of client-side or locally residing computer code that enables the interactive steps required to specify the manufacturing specifications for confetti customized with imagery. This aspect of the invention allows the client to interact with a private copy of computer code such that individual manipulation operations do not incur the time penalty of a network communication with the remote manufacturing service or server. Such an approach reduces the demand on the server hardware providing the remote service 200 as the majority of the product customizing agent 400 steps are performed on the client's hardware.

The product customizing specification steps for the preferred embodiment of customizing confetti with digital imagery are illustrated in FIG. 3 as the steps of select physical parameters 4121, select colors 4122, select customizing text messages 4123, select themes 4124, and crop selected images 4125. Each of these steps are interactive steps wherein the agent 400 derives detailed manufacturing specifications which are added to a specification queue 4220 via a non-interactive process.

In the first step of the invention detailed in FIG. 3, the client selects image content 4110 with which to customize the manufacture of the confetti product. In one instance of the invention, digital photographic image files, such as JPEG, GIF, PNG, TIFF, BMP or other digital image format files, are selected from the client device or computer file system. One implementation of selection uses HTML file select form elements together with cascading style sheet (CSS) and JavaScript computer code to access the client file system. Selected content files are verified for accepted format and validity and displayed visually to the user. The selected files are stored in an image content queue 4210 for later asynchronous transfer to the remote service manufacturing site. Content files selected in this manner may be previewed, duplicated, deleted, and manipulated in a number of operations consistent with the manufacturing operations supported by the invention. In one instance of the invention, JPEG format image files are displayed in a consistent and small size format, also commonly referred to as “thumbnails” and these thumbnails may be selected by use of a computer screen pointing device, such as a mouse, or other input device and selected content files may then be deleted or duplicated or otherwise manipulated in a manner consistent with the invention.

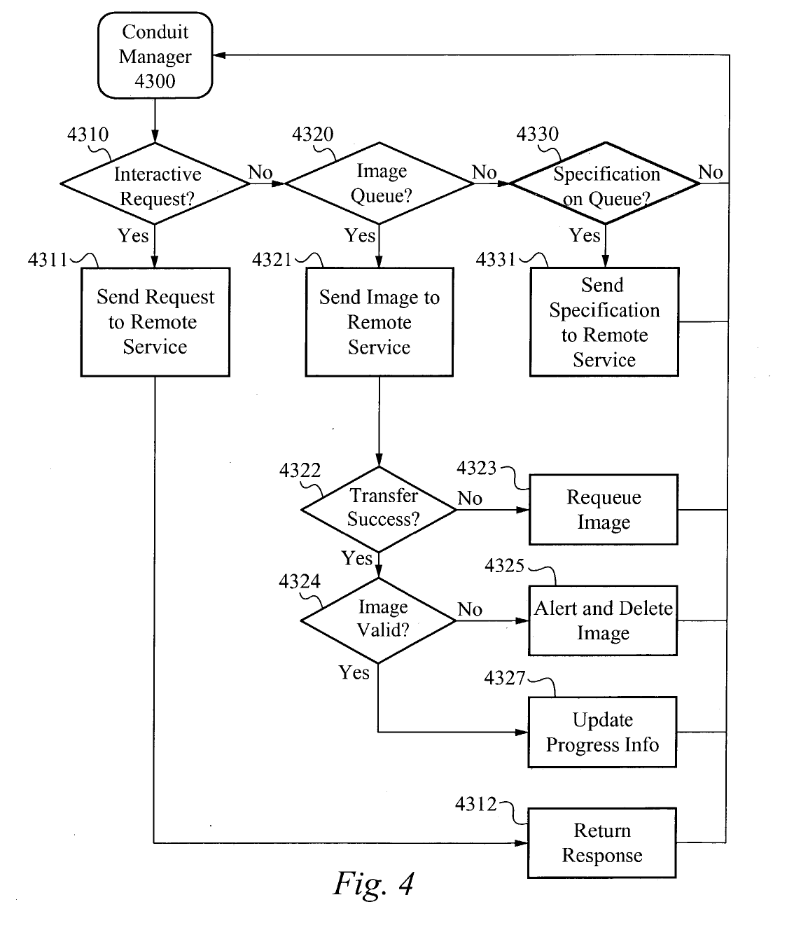

Upon the client choice of subsequent steps of the invention, or immediately upon the selection of same content files, a conduit manager 4300, whose process flow is illustrated in FIG. 4, is activated to transmit image content located elsewhere from the remote service to the remote service. A client side data routing scheme is employed in the invention to stop the transfer of non-interactive content when agent description language code, typically HTML or XML language, is requested by other aspects of the invention, via a client interactive request, from the remote service 200 via the shared transmission conduit 300. Such a scheme mitigates the issue that many web browsers do not balance network requests for data between concurrently running processes on the client side browser. This aspect of the invention stops concurrent processes when high priority data is requested through user action and then restarts the stopped concurrent processes when the transfer of high priority data is complete. An instance of this part of the invention occurs when the interaction of the client requests the transfer of information required for a new step from the remote server while the queued content images in the image content queue 4210 or the queued manufacturing specifications in the specification queue 4220 are concurrently being transferred. The queued data transfer would, in standard operation, compete for finite transmission conduit 300 bandwidth with the requested high priority interactive request of page description code. In this instance, the content transfer of data to the remote service 200 is temporarily halted until the receipt of the requested interactive step is completed. The image content queue is then resumed until such time that client interactions request an additional high priority interactive step.

As illustrated in FIG. 4, the invention employs a non-interactive conduit manager 4300 process which prioritizes and supervises requests and transfers to the remote service 200. These requests are either interactive requests 4310, image content transfer requests 4320, or specification data requests 4330. While requests are pending, the conduit manager 4300 first services interactive requests 4310. If such a request is queued for transfer, the conduit manager 4300 sends the request to the remote service 4311 and returns the response to the customizing agent 4312. If no interactive requests exist, in the step 4320 the conduit manager 4300 checks the image content queue 4210 for any image content files that the client has selected for inclusion in the manufactured confetti product. If any such content transfer requests exist, this process manages the transfer of content to a remote service and receives, displays and communicates status information to other parts of the invention. Such a process affords the concurrent transfer of selected content data to the remote service during such times when subsequent client actions in specifying other manufacturing criteria does not require server intervention or data transfer. If, in the step 4322, the image content transfer is found to have failed, the image content is reinserted into the image content queue 4210 for a subsequent transfer attempt. If, in the step 4322 the image content transfer is found to have succeeded, then in the step 4324, the validity of the image format based on information returned by the remote service 200 is checked. If, in the step 4324, the image is determined to be invalid, the image is deleted from the interactive process and the agent and client are alerted at the step 4325. If, in the step 4324, the image format is found to be valid, the conduit manager 4300 process receives timing and status information from the remote service and uses this information to update transfer progress information at the step 4327 to the interactive invention process and predicts the transfer time of any remaining queued image content 4210. Thus, for each image queued for transfer by the interactive process in the image content queue 4210, the conduit manager 4300 updates the interactive process on the success or failure of the transfer, reports the validity of the image format, allows the retry of the transfer, and uses the knowledge of the timing information to predict to the interactive client the time remaining for the transfer of items still remaining in the queue. Standard web or HTTP protocol based transfers do not allow the prediction of timing information. This aspect of the invention allows the prediction of timing information. In one aspect of this predictive algorithm, all the content file sizes are assumed to be of the same size. Average transfer times for content files already sent are multiplied by the number of files remaining in the image content queue 4210 to predict the time remaining for transfer. Once one content file has been transferred, any subsequently queued content file's transfer time may be accurately predicted as the bandwidth and file size of a client in a given session is asserted to remain constant.

The conduit manager process 4300 receives information at the step 4324 from the remote service on the validity of client selected content types. The content file types which are not supported by the manufacturing process are communicated back to the product customizing agent for appropriate action and exclusion. In one instance of this process, a client selecting an image type or file which is not supported or recognized by an instance of the manufacturing process is notified that said image is not supported after the conduit manager 4300 receives information from the remote service 200 that the uploaded content file type is not supported by the manufacturing process.

In another part of the invention, clients interactively select the physical form factors 4121, colors 4122, text 4123, thematic elements 4124, and crop images 4125 selected to customize the manufactured confetti product. The invention supports actions such as the selection of colors 4122 of accent confetti pieces to be mixed into the order of confetti customized with imagery, the selection of cropping shapes, sizes, and material types 4121 for the confetti pieces, the content and format of a personalized text message 4123, and the choice of pre-prepared themes of licensed copyrighted photographs, artwork, or illustration 4124 to be included in the confetti order. The invention supports the choice of colors in the following manner: by the selection of a sub set of colors from a predetermined palette, by the specification of color values through RGB values, CMYK values, named colors, pantone values, or other custom or proprietary means of color determination.

The invention supports the selection of personalized text messages 4123 on the accent and photographic confetti pieces by allowing the customer to specify a text message and choose from menus of text formatting options and color palettes. The text message is presented in a preview displaying the form in which it would actually appear in the final product by using cascading style sheet (CSS) and client-side JavaScript or other web browser supported scripting languages.

The invention supports the selection of physical custom confetti cropping shapes 4121 through the use of client side scripting EMCA or JavaScript code together with cascading style sheet (CSS) specifications and layered image masks in the specified shapes. The viewing of cropped images and cropping tools is supported by supplying a suite of image resources corresponding to each of the supported cropping shape options. The user, having selected a cropping shape and form factor, in subsequent steps positions the cropping tool and zooms, pans, rotates, and scales the target image in such a manner that the selected area is specified. The invention then allows the immediate preview of the cropped area without remote server intervention or manipulation of the source image by preferably using CSS properties and layers to mask the target image with the appropriate mask image resource selected by the user in a prior step. The choice of mask can be dynamically changed again without remote service 200 intervention. Such an approach is novel in that it works entirely locally without server intervention and incurs neither network latency or delay and does not tax the resources of the remote service 200 hardware for user specification operations.

In another part of the invention illustrated in the step 4125, the user adjusts the magnification, orientation, position, and cropping section of the photographic content to be displayed on the surface of the photographic confetti. Thumbnails of all the selected images are displayed to the user in a reduced form by means of standard reduction algorithms supported by CSS properties. The user selects a photographic image by using a pointing device or keyboard input to select its corresponding thumbnail that is then displayed at an enlarged size in the image manipulation region. A cropping image of the user specified shape is displayed by means of CSS layers that allow two images to share the same coordinate positions on a page. The cropping tool floats in a layer above the image so that it appears to delineate a cropping region. The user may then move the cropping tool around the image by “dragging” with the mouse or activating appropriate buttons which move the cropping tool or image in cardinal directions, again by computer pointing device, mouse, or keyboard. The user may also magnify, crop, or zoom the image by use of tools that affect the desired actions. When zooming the image, the image remains centered on the area by the visible cropping tool. The image may also be itself panned or scrolled in any of the cardinal directions by moving the cropping tool, by mouse drag or tool, into the edge of the image manipulation region. Upon encountering the edge of the image manipulation region, the cropping tool itself ceases to move whereas the image itself is moved in the opposite direction from the user input, affecting the desired action, while constraining the cropping tool within a limited area on the device screen.

Once the selected region for cropping has been identified, the invention affords the user the opportunity to save the selected cropping region by selecting a “save” or crop action. Such action then displays the image thumbnail as the actual cropped region by application of the appropriate image mask resource and user specified pan, zoom, and rotation values.

The invention also supports other actions such as deletion, duplication, and remote server mediated image processing.

Concurrent with the customizing steps 4121-4125, a non-interactive process is used to derive detailed manufacturing specifications which are queued for asynchronous transfer to the remote service via the conduit manager 4300 in the specification queue 4220. If, in the step 4320 of FIG. 4, no images are found in the image content queue 4210, then the specification queue 4220 is checked by the conduit manager 4300. If manufacturing specifications are found within the specification queue 4220, they are transmitted to the remote service in the step 4331.

After the specification of confetti product customization steps 4121-4125, the user may preview their confetti product 4130 according to the manufacturing specifications they have selected. In this part, the cropped images are displayed according to the size, shape, position, magnification, and other values selected. The preview is accomplished by means of using CSS properties to position and scale the image on the page, and the application of a masked image resource in a layer above the image to provide the detailed arbitrary crop shape selected by the user, and a clipping region to hide and exclude other areas of the image not masked by the finite sized mask resource. Additional elements of the product order, such as accent color confetti, are also depicted in the preview by using additional layers above the mask to array the selected mix of colors and other elements. In one instance of this part of the invention, the photographic image is displayed appropriately sized, magnified, rotated, filtered, and positioned in the lowest layer, clipped using CSS properties to the size of the cropping mask resource dimensions. The crop mask resource of the appropriate selected shape is displayed above the image in a higher layer which covers the part of the image not masked by the clipping region in a manner where the mask only makes visible that part of the underlying image that is in the desired shape and in the user selected position. In higher layers still, additional image resources depicting the size, shape, approximate positions, and user selected colors of accent confetti are positioned such that the entire layered stack of images gives rise to an accurate preview representation of the final product when strewn on a surface for decoration.

Upon review of the customized confetti in the step 4130, the client can either return to the step 4110 to select additional image content or delete existing image content or further customize the confetti product in the customizing steps 4121-4125 and then return to preview the confetti in the step 4130. This process may be repeated as many times as required by the user to customize the confetti to desired specifications. If the preview is approved, the client can place a manufacture order 4140 which completes the interactive process. In the place order step 4140 of the invention, the client preferably transacts with a standard commerce mechanism to purchase or otherwise arrange for the delivery of the manufactured confetti as specified. Once the order has been placed, the non-interactive process checks to ensure that all queued content has been successfully transferred and waits until all queued content is sent at the step 4150. Once all queued content has been sent, the client-side process ends at the step 5000 and control transfers to the remote service 200 to complete the manufacture and delivery of the customized confetti product as specified.

Another logical aspect of the invention is the processes that accept and assemble user provided content and specification values and process these into a form factor appropriate for the manufacture of the product. The image content and the specification values for that process are then processed by the remote service to complete the source material and specifications 210 needed to manufacture the product. This processed information is then used to manufacture the customized confetti product 220 which is delivered 230 to the customizing client.

The present invention has been described in terms of specific embodiments incorporating details to facilitate the understanding of principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

We claim:

1. A method of generating a customized product incorporating digital media, comprising:
a. facilitating interactive communications between the client and a server;
b. sending the digital media from the client to the server during periods of time in which there are no interactive communications; and
c. sending specifications for customizing the product to the server.

2. The method as claimed in claim 1 wherein the digital media is resident at the client.

3. The method as claimed in claim 2 wherein the digital media is available without intervention from the server.

4. The method as claimed in claim 1 wherein the specifications are stored for sending within a specifications queue at the client.

5. The method as claimed in claim 1 wherein the specifications include modifications of the digital media.

6. The method as claimed in claim 1 further comprising sending an agent from the server to the client, wherein the agent facilitates customization of the product at the client.

7. The method as claimed in claim 6 wherein the agent generates the specifications based on the customization.

8. The method as claimed in claim 7 wherein the specifications are generated at the client without intervention from the server.

9. The method as claimed in claim 1 wherein sending the digital media further comprises using dynamic HTML technologies to generate a queue of content including the digital media.

10. The method as claimed in claim 1 wherein the digital media includes one or more digital images.

11. The method as claimed in claim 1 wherein the specifications include one or more of changes to size of the digital media, changes to shape of the customized product, and changes to a form factor of the customized product.

12. The method as claimed in claim 1 wherein the customized product is confetti with one or more personalized images.

13. The method as claimed in claim 1 wherein the digital media includes one or more of an audio file, a video file and a text file.

14. The method as claimed in claim 1 further comprising utilizing secondary media resident at an address within the customized product.

15. The method as claimed in claim 14 wherein the address is at the server.

16. The method as claimed in claim 14 wherein the address is at a location remote from the client and the server.

17. The method as claimed in claim 1 further comprising providing an interface at the client through which the specifications for customizing the product are received, wherein sending the digital media is performed while the specifications of the digital media are received.

18. The method as claimed in claim 1 further comprising providing a preview of the customized product through an interface at the client.

19. The method as claimed in claim 18 wherein the preview of the customized product includes the digital media as it is to appear on the customized product.

20. The method as claimed in claim 18 wherein the preview includes layered images of shapes corresponding to the customized product.

21. The method as claimed in claim 20 wherein CSS layered image resources are used to provide the preview.

22. The method as claimed in claim 18 wherein the preview includes layered partially transparent images corresponding to the customized product.

23. The method as claimed in claim 1 further comprising estimating a remaining time for transmission of a second set of the digital media based on an elapsed time for transmission of a first set of the digital media.

24. The method as claimed in claim 23 wherein the first set includes one or more digital media files each having a size and further wherein estimating includes determining a time for transmission of each file of the first set and multiplying the time of transmission for each file by a number of files within the second set.

25. The method as claimed in claim 1 wherein the client and server are coupled together by one or more of a direct connection, a network connection, an internet connection and a wireless connection.

26. A method of generating a customized product incorporating digital media resident at a client through a communications link between the client and a server, the communications link having a bandwidth, comprising:
a. facilitating interactive communications between the client and a server;
b. sending the digital media from the client to the server when at least a portion of the bandwidth is available; and
c. sending specifications for customizing the product to the server.

27. The method as claimed in claim 26 wherein a priority is set for use of the bandwidth.

28. The method as claimed in claim 27 wherein the interactive communications have first priority for the bandwidth.

29. The method as claimed in claim 27 wherein the priority is set dynamically based on current conditions.

30. The method as claimed in claim 26 wherein the digital media is resident at the client.

31. The method as claimed in claim 30 wherein the digital media is available without intervention from the server.

32. The method as claimed in claim 26 wherein the specifications are stored for sending within a specifications queue at the client.

33. The method as claimed in claim 26 wherein the specifications include modifications of the digital media.

34. The method as claimed in claim 26 further comprising sending an agent from the server to the client, wherein the agent facilitates customization of the product at the client.

35. The method as claimed in claim 34 wherein the agent generates the specifications based on the customization.

36. The method as claimed in claim 35 wherein the specifications are generated at the client without intervention from the server.

37. The method as claimed in claim 26 wherein sending the digital media further comprises using dynamic HTML technologies to generate a queue of content including the digital media.

38. The method as claimed in claim 26 wherein the digital media includes one or more digital images.

39. The method as claimed in claim 26 wherein the specifications include one or more of changes to size of the digital media, changes to shape of the customized product, and changes to a form factor of the customized product.

40. The method as claimed in claim 26 wherein the customized product is confetti with one or more personalized images.

41. The method as claimed in claim 26 wherein the digital media includes one or more of an audio file, a video file and a text file.

42. The method as claimed in claim 26 further comprising utilizing secondary media resident at an address within the customized product.

43. The method as claimed in claim 42 wherein the address is at the server.

44. The method as claimed in claim 42 wherein the address is at a location remote from the client and the server.

45. The method as claimed in claim 26 further comprising providing an interface at the client through which the specifications for customizing the product are received, wherein sending the digital media is performed while the specifications of the digital media are received.

46. The method as claimed in claim 26 further comprising providing a preview of the customized product through an interface at the client.

47. The method as claimed in claim 46 wherein the preview of the customized product includes the digital media as it is to appear on the customized product.

48. The method as claimed in claim 46 wherein the preview includes layered images of shapes corresponding to the customized product.

49. The method as claimed in claim 48 wherein CSS layered image resources are used to provide the preview.

50. The method as claimed in claim 46 wherein the preview includes layered partially transparent images corresponding to the customized product.

51. The method as claimed in claim 26 further comprising estimating a remaining time for transmission of a second set of the digital media based on an elapsed time for transmission of a first set of the digital media.

52. The method as claimed in claim 51 wherein the first set includes one or more digital media files each having a size and further wherein estimating includes determining a time for transmission of each file of the first set and multiplying the time of transmission for each file by a number of files within the second set.

53. The method as claimed in claim 26 wherein the client and server are coupled together by one or more of a direct connection, a network connection, an internet connection and a wireless connection.

54. A system for communicating with a server to generate a customized product incorporating digital media resident at the system, comprising:
a. a communications circuit configured to communicate with the server through a communications link having a bandwidth;
b. a storage circuit coupled to the communications circuit for storing the digital media; and
c. a control circuit coupled to the communications circuit and to the storage circuit for facilitating interactive communications with the server, sending the digital media from the storage circuit during periods of time in which at least a portion of the bandwidth is available and sending specifications for customizing the product to the server.

55. The system as claimed in claim 54 wherein the control circuit sets a priority for use of the bandwidth.

56. The system as claimed in claim 55 wherein the interactive communications have first priority for the bandwidth.

57. The system as claimed in claim 55 wherein the priority is set dynamically based on current conditions.

58. The system as claimed in claim 54 wherein the storage circuit includes a content queue for storing the digital media.

59. The system as claimed in claim 54 wherein the storage circuit further includes a specifications queue for storing the specifications for sending.

60. The system as claimed in claim 54 wherein the specifications include modifications of the digital media.

61. The system as claimed in claim 54 wherein an agent is received from the server and used by the control circuit in the customization of the product and the generation of the specifications.

62. The system as claimed in claim 61 wherein the specifications are generated at the client without intervention from the server.

63. The system as claimed in claim 54 wherein the control circuit utilizes dynamic HTML technologies to generate a queue of content including the digital media when sending the digital media.

64. The system as claimed in claim 54 wherein the digital media includes one or more digital images.

65. The system as claimed in claim 54 wherein the specifications include one or more of changes to size of the digital media, changes to shape of the customized product, and changes to a form factor of the customized product.

66. The system as claimed in claim 54 wherein the customized product is confetti with one or more personalized images.

67. The system as claimed in claim 54 wherein the digital media includes one or more of an audio file, a video file and a text file.

68. The system as claimed in claim 54 wherein the digital media is available without intervention from the server.

69. The system as claimed in claim 54 further comprising an interface through which the specifications for customizing the product are received, wherein sending the digital media is performed while the specifications of the digital media are received.

70. The system as claimed in claim 69 wherein a preview of the customized product is provided through the interface.

71. The system as claimed in claim 70 wherein the preview of the customized product includes the digital media as it is to appear on the customized product.

72. The system as claimed in claim 70 wherein the preview includes layered images of shapes corresponding to the customized product.

73. The system as claimed in claim 72 wherein CSS layered image resources are used to provide the preview.

74. The system as claimed in claim 70 wherein the preview includes layered partially transparent images corresponding to the customized product.

75. The system as claimed in claim 54 wherein the communications circuit is coupled to the server by one or more of a direct connection, a network connection, an internet connection and a wireless connection.

76. A server for communicating with one or more clients to generate customized product incorporating digital media from the client, comprising:
a. a communications circuit configured to communicate with the clients through a communications link having a bandwidth; and
b. a control circuit coupled to the communications circuit for facilitating interactive communications with the clients, receiving the digital media from the clients during periods of time in which at least a portion of the bandwidth is available and receiving specifications for customizing the product made at the client.

77. The server as claimed in claim 76 wherein the interactive communications have first priority for the bandwidth.

78. The server as claimed in claim 76 wherein the specifications include modifications of the digital media.

79. The server as claimed in claim 76 wherein the control circuit sends an agent to the client, wherein the agent facilitates customization of the product at the client.

80. The server as claimed in claim 79 wherein the agent generates the specifications based on the customization.

81. The server as claimed in claim 80 wherein the specifications are generated at the client without intervention from the server.

82. The server as claimed in claim 76 wherein the digital media includes one or more digital images.

83. The server as claimed in claim 76 wherein the specifications include one or more changes to size of the digital media, changes to shape of the customized product, and changes to a form factor of the customized product.

84. The server as claimed in claim 76 wherein the customized product is confetti with one or more personalized images.

85. The server as claimed in claim 76 wherein the digital media includes one or more of an audio file, a video file and a text file.

86. The server as claimed in claim 76 wherein the communications circuit is coupled to the client by one or more of a direct connection, a network connection, an internet connection and a wireless connection.

87. A network of devices comprising:
a. a server configured to generate customized product incorporating digital media, the server including:
i. a server communications circuit; and
ii. a server control circuit coupled to the communications circuit; and
b. one or more clients for communicating with the server to generate the customized product, each of the clients including:
i. a client communications circuit configured to communicate with the server through a communications link having a bandwidth;
ii. a storage circuit coupled to the client communications circuit for storing the digital media; and
iii. a client control circuit coupled to the client communications circuit and to the storage circuit for facilitating interactive communications with the server, sending the digital media from the storage circuit during periods of time in which at least a portion of the bandwidth is available and sending modifications of the digital media to the server.

88. The network as claimed in claim 87 wherein the client control circuit sets a priority for use of the bandwidth.

89. The network as claimed in claim 88 wherein the interactive communications have first priority for the bandwidth.

90. The network as claimed in claim 88 wherein the priority is set dynamically based on current conditions.

91. The network as claimed in claim 87 wherein the specifications include modifications of the digital media.

92. The network as claimed in claim 87 wherein an agent is sent from the server to the clients and used by the client control circuit in the customization of the product and the generation of the specifications.

93. The network as claimed in claim 92 wherein the specifications are generated at the client without intervention from the server.

94. The network as claimed in claim 87 wherein the digital media includes one or more digital images.

95. The network as claimed in claim 87 wherein the specifications include one or more of changes to size of the digital media, changes to shape of the customized product, and changes to a form factor of the customized product.

96. The network as claimed in claim 87 wherein the customized product is confetti with one or more personalized images.

97. The network as claimed in claim 87 wherein the digital media includes one or more of an audio file, a video file and a text file.

98. The network as claimed in claim 87 wherein each of the clients further comprise an interface through which the specifications for customizing the product are received, wherein sending the digital media is performed while the specifications of the digital media are received.

99. The network as claimed in claim 98 wherein a preview of the customized product is provided through the interface.

100. The network as claimed in claim 99 wherein the preview of the customized product includes the digital media as it is to appear on the customized product.

101. The network as claimed in claim 99 wherein the preview includes layered images of shapes corresponding to the customized product.

102. The network as claimed in claim 101 wherein CSS layered image resources are used to provide the preview.

103. The network as claimed in claim 99 wherein the preview includes layered partially transparent images corresponding to the customized product.

104. The network as claimed in claim 87 wherein the server communications circuit is coupled to the client communications circuit by one or more of a direct connection, a network connection, an internet connection and a wireless connection.
